(19) United States
(12) Patent Application Publication
(10) Pub. No.: US 2003/0235249 A1
(43) Pub. Date: Dec. 25, 2003

(54) Video encoder and method for encoding video frames

(76) Inventors: Chengji Zhao, Singapore (SG); Jian Zhang, Enfield (AU); Reji Mathew, Riverwood (AU)

Correspondence Address: MOTOROLA, INC., 1303 EAST ALGONQUIN ROAD, IL01/3RD, SCHAUMBURG, IL, 60196

(21) Appl. No.: 10/179,068

(22) Filed: Jun. 25, 2002

(51) Int. Cl. H04N 7/12

(52) U.S. Cl. 375/240.13; 375/240.01; 375/240.12

(57) ABSTRACT

A video encoder (2) comprises an encoder unit (4) coupled to a transmission circuit (6), the encoder unit (4) further comprising a counter (5) and a comparator (7). Frames of a video sequence (8) comprise areas encoded as an inter-coded area or an intra-coded area. The counter (5) maintains an inter-coding history count value for identified potential inter coded areas of a frame thereby identifying a number of times said potential inter-coded area depends from inter-coded areas of consecutive frames. The encoder unit (4) determines if any of the potential inter-coded areas is to be intra-coded or inter-coded, the determining being dependent upon comparing each count value with the threshold count value.

### FIELD OF THE INVENTION

This invention relates to encoding video frames. The invention is particularly useful for, but not necessarily limited to, real-time video encoding and transmission of video over error prone networks.

### BACKGROUND ART

Video is now a common component of multimedia communications and in an attempt to transmit video sequences efficiently over communication channels video sequences are encoded and compressed. Typically, video sequences are compressed according to video compression standards such as H.263 and MPEG-4.

Such compression standards exploit the temporal and spatial redundancies in a video sequence to reduce the bandwidth required for transmission. For example, two consecutive frames in a video sequence often differ only slightly and compression techniques may take advantage of the redundancy in the two frames by only encoding the differences between them. However, this differential encoding creates dependencies between successive frames and therefore, if image blocks in one frame are incorrectly coded, the resultant error will propagate to the next, dependent frame. This form of predictive coding is referred to as inter-frame coding.

One way to prevent error propagation is to ‘refresh’ the data by encoding data from one frame independently of data from a previous frame. This form of encoding is referred to as intra-frame coding and is equivalent to encoding the video sequence as a series of independent images. An error in one image frame does not affect the coding of the other image frames and thus, error propagation is not an inherent feature of intra-frame coding. However, this form of encoding seriously reduces the compression gain and transmission efficiency.

To prevent serious quality degradation, it is important to increase the error resilience of the compressed video data sequence.

An error resilient video encoder is disclosed in U.S. Pat. No. 5,793,895 assigned to International Business Machines Corp., wherein each frame of a video image is partitioned into a set of macroblocks. For each macroblock, a coding control function evaluates the result of a motion estimation of the macroblock and decides either to encode the difference between the macroblock and its previous occurrence (inter-frame encoding), or to encode the new value independently of any previous data (intra-frame encoding). For each inter-coded block, a motion vector is associated with it which points to the location of its previous occurrence. An inter-coded block is referred to as a P-block and an intra-coded block is referred to as an I-block. I-block encoding exploits only the spatial redundancy within the block, while P-block encoding exploits both the temporal and spatial redundancies of the video. This is known as the best matching prediction method for encoding video frames.

In U.S. Pat. No. 5,793,895 a macroblock updating module analyses motion vector data to identify those macroblocks that have the most impact on successive frames. The importance of a macroblock is measured by its dependence count, which is defined as the number of blocks depending on it in successive frames. If the dependence count of the macroblock equals or exceeds a preset dependence threshold T, that macroblock is selected to be intra-coded as an I-block. Otherwise, that macroblock will be inter-coded as a P-block. This analysis is repeated until the first frame of a video sequence is reached.

In addition to the above, the number of macroblocks eligible for intra-coding is also monitored and if the total number exceeds a threshold β, the macroblocks are sorted according to their dependency count and β of those blocks with the highest dependency are selected for intra-coding, with their dependency count being set to zero. This is also repeated until the first frame of the video sequence is reached. Hence, one drawback of this encoder is exhibited when the threshold β is exceeded. Some of the macroblocks that ought to be intra-coded to prevent error propagation, but do not have sufficiently high dependency counts, will not be intra-coded. Furthermore, this method is not suitable for real-time video encoding.

Another video encoding method and apparatus is disclosed in U.S. Pat. No. 6,025,888 assigned to Lucent Technologies Inc., wherein, for each macroblock position of a frame, a metric is maintained to determine those macroblock positions that are more likely than others to improve the decoded video image quality if refreshed (intra-coded). The metric may be based on a count of the number of times a macroblock position has been coded since it was last refreshed. The macroblock positions with the highest counts are refreshed and transmitted in intra-coded form and the counts for the positions of the refreshed blocks are then reset to zero. One disadvantage of this method is that because the highest counts are refreshed, there is a risk that blocks will be refreshed earlier than necessary, thus reducing encoding efficiency.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method of encoding video frames of a video sequence, wherein the frames are divided into areas encoded as either an inter-coded area or an intra-coded area, the inter-coded area having a dependency upon a coded area of a previous frame and the intra-coded area having no dependency upon any coded area of a previous frame, said encoding method including the steps of:

identifying potential inter coded areas of a frame;

maintaining an inter-coding history count value for each of the potential inter-coded areas to be coded, said inter-coding history count value identifying a number of times said potential inter-coded area depends from inter-coded areas of previous consecutive said frames; and

determining if any of said potential inter-coded areas is to be intra-coded or inter-coded, said determining being dependent upon comparing said inter-coding history count value with a threshold value.

Suitably, said step of maintaining said inter-coding history count value for each of said potential inter-coded areas may include incrementing inter-coding pixel history count values for each pixel in the potential inter-coded area with corresponding pixels having an identical relative positions in the inter-coded areas in previous consecutive frames, wherein the inter-coding history count value is obtained from the inter-coding pixel history count values.

Suitably, said step of maintaining said inter-coding history count value for each of said potential inter-coded areas may include resetting the inter-coding pixel history count values for each pixel in the potential inter-coded area, the resetting being effected if the potential inter-coded area is intra-coded.

Preferably, the method may be further characterized by said potential inter-coded area occupying a different area position than an associated inter-coded area in a previous frame.

Preferably, said method steps may be preceded by an initialization step wherein the areas of said frames are either inter-coded or intra-coded.

Preferably, the initialization step can be characterized by said areas of said frames are either inter-coded or intra-coded according to a pre-programmed selective ratio.

Suitably, the initialization step may be effected until a predefined number of initial frames have been coded.

According to another aspect of the invention there is provided a video encoder in which frames of a video sequence are divided into areas encoded as either an inter-coded area or an intra-coded area, an inter-coded area having a dependency upon a coded area of previous frame and an intra-coded area having no dependency upon any coded area of a previous frame, said video encoder comprising:

a counter which maintains an inter-coding history count value for each identified potential inter coded area of a frame said inter-coding history count value identifying a number of times said potential inter-coded area depends from inter-coded areas of previous consecutive said frames;

a comparator which compares each said inter-coding history count value with a threshold count value; and

an encoder unit which determines if any of said potential inter-coded areas is to be intra-coded or inter-coded, said determining being dependent upon comparing each said inter-coding history count value with said threshold count value.

Suitably, the counter may maintain said inter-coding history count value for each of said potential inter-coded areas and in use increments inter-coding pixel history count values for each pixel in the potential inter-coded area with corresponding pixels having an identical relative positions in the inter-coded areas in previous consecutive frames, wherein the inter-coding history count value is obtained from the inter-coding pixel history count values.

Suitably, the counter may maintain said inter-coding history count value for each of said potential inter-coded areas may in use reset the inter-coding pixel history count values for each pixel in the potential inter-coded area, the reset being effected if the potential inter-coded area is intra-coded.

Preferably, the video encoder can be adapted to perform an initialization step in which the areas of said frames are either inter-coded or intra-coded.

Preferably, the initialization step can be characterized by said areas of said frames are either inter-coded or intra-coded according to a pre-programmed selective ratio.

Suitably, the initialization step may be effected until a predefined number of initial frames have been coded.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a block diagram of a video encoder in accordance with the invention;

FIG. 2A is a first part of a flow chart illustrating a method of encoding video frames of a video data stream in accordance with the invention;

FIG. 2B is a second part of the flow chart shown in FIG. 2A;

FIG. 3A is a schematic diagram illustrating a simplified example of encoding video frame areas or macroblocks of a video sequence in accordance with the invention; and

FIG. 3B is a schematic diagram representing inter-coding history count values of the macroblocks of FIG. 3A.

### DETAILED DESCRIPTION OF THE PREFERRED EMBODIMENT OF THE INVENTION

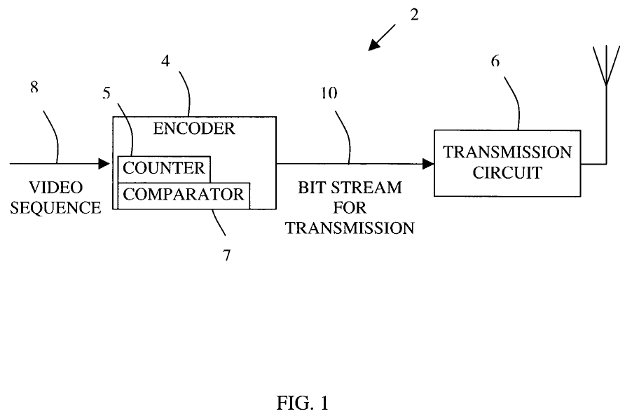

In the drawings, like numerals on different FIGS. are used to indicate like elements throughout. With reference to FIG. 1, there is illustrated a video encoder 2 comprising an encoder unit 4 coupled to a transmission circuit 6. The encoder unit 4 further comprises a counter 5 and a comparator 7.

The encoder unit 4 receives a video sequence 8 comprising a sequence of frames. After encoding and compressing a frame, the encoder unit 4 passes the resultant bit stream 10 to the transmission circuit 6 for transmission over a communication channel (typically by a radio or cable link). Encoding performed by the encoder 2 is in accordance with the method described below and compression is performed in accordance with a known compression standard such as H.263 and MPEG-4.

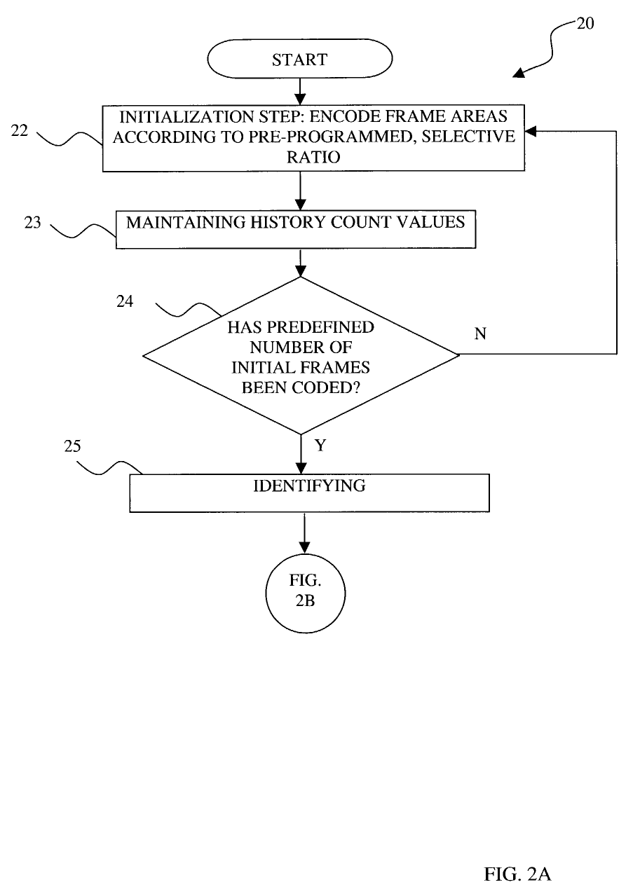

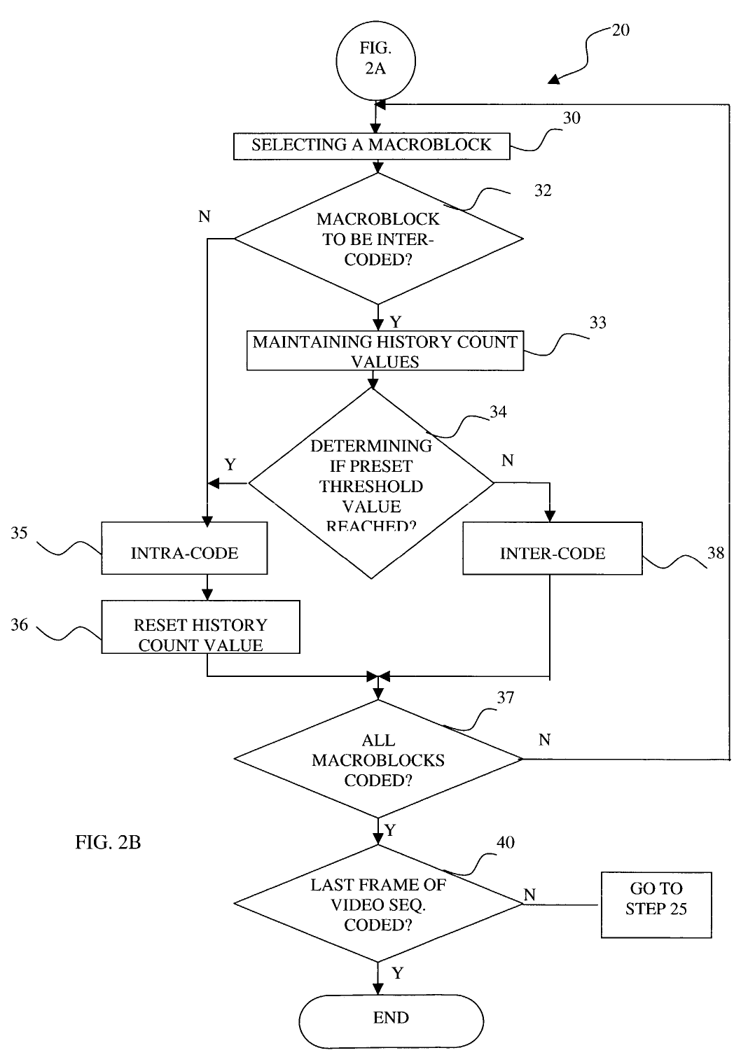

In operation, the present invention provides a method 20 (effected by the video encoder 2) of encoding video frames of a video sequence as described with reference to the flow chart in FIGS. 2A and 2B. In the method 20, the frames are divided into areas (macroblocks) encoded as either an inter-coded area or an intra-coded area, the inter-coded area having a dependency upon a coded area of a previous frame and the intra-coded area having no dependency upon any coded area of a previous frame.

With reference to FIG. 2A, the method 20 firstly effects an initialization step 22 wherein frames of a video sequence are initially encoded according to a pre-programmed, selective ratio. For example, areas comprising the frames, such as macroblocks of pixels, may be encoded according to a ratio whereby 90% of the macroblocks in a current frame are inter-coded areas (P-blocks) and 10% of the macroblocks are intra-coded areas (I-blocks). The locations of macroblocks that are to be intra-coded can be predetermined such that after 10 frames 100% of all macroblock locations would be intra-coded at least once. However, it will be appreciated that the ratio (of intra-coded macroblocks to inter-coded macroblocks for each frame) may be different for different applications.

An inter-coding history count value is maintained, at step 23, and maintains an inter-coding pixel history count value for each pixel of every macroblock in a frame. When a macroblock is inter-coded, the inter-coding pixel history count value for every pixel of the macroblock is incremented by 1. When a macroblock is intra-coded, the inter-coding pixel history count values for every pixel of the macroblock is reset to zero. The macroblock position will typically vary from frame to frame and thus the associated inter-coding history count values are determined from analysis of the inter-coding pixel history count values for each pixel in the current macroblock (potential inter-coded area) with corresponding pixels having an identical relative positions in the best matching macroblocks (coded areas) in previous consecutive frames. Thus, the inter-coding history count values are obtained from the inter-coding pixel history count values. As will be apparent to a person skilled in the art, the inter-coding history count value identifies the number of times the potential inter-coded area depends on inter-coded areas of consecutive frames.

Steps 22 and 23 are repeated until a predefined number of initial frames of a video sequence have been coded. For example, 40 frames may be coded using the predefined selective ratio method 22. Step 23 also maintains a frame count until the predefined number of the frames are coded (e.g. 40 frames). A test step 24 compares the number of coded frames to a predetermined number of initial frames that are to be coded using method 22. Once the predetermined number of frames have been coded, the method 20 proceeds to step 25.

Once the initial predefined number of frames have been coded, subsequent frames of the video sequence are coded where the inter-coding history count value determining those macroblocks that can be coded as inter or intra.

In step 25 there is effected process of identifying potential inter coded areas of a current frame. In the identifying step 25, the complete area of the current frame is analyzed for coding of all macroblocks therein as potentially inter-coded areas.

Inter coding requires comparison or macroblock matching techniques and preferably this invention uses Sum of Absolute Difference (SAD) as described by Viet L. Do and Kenneth Y. Yun, in “A Low-Power VLSI Architecture for Full-Search Block-Matching Motion Estimation”, IEEE Transactions on Circuits and Systems for Video technology, Vol. 8, No. 4, August 1998, and is incorporated into this specification by reference.

Each time a macroblock is to be inter-coded (i.e. a potential inter coded area) the inter-coding pixel history count values associated with that macroblock are incremented.

The method 20 then continues with a selecting a macroblock step 30, as shown to FIG. 2B, where step 30 selects a macroblock of the current frame and an enquiry is made, at a test step 32, to determine if the selected macroblock is a potential inter-coded area. If the step 32 determines that the selected macroblock is not a potential inter-coded area an intra-coding step 35 is effected, otherwise the inter-coding history count value of the number of times the macroblock (potential inter-coded area) is dependent upon successive inter-coded previous macroblocks (areas) is updated (maintained) by the counter 5 at a maintaining step 33. The inter-coding history count value is based on each pixel's inter-coding pixel history count for the macroblock and therefore to obtain a historical count for a macroblock, a simple average inter-coding pixel history count of each pixel of the macroblock can be used. For example a macroblock of dimensions 16×16 contains 256 pixels. The inter-coding history count value of the selected macroblock can be obtained by calculating an average inter-coding history count value from the 256 inter-coding pixel history count values. Note that other techniques other than calculating an average can be used to determine a macroblock inter-coding history count value. The comparator 7 then effects a determining test step 34 then compares the selected macroblock inter-coding history count value against a preset threshold count value.

If at step 34, the inter-coding history count value for the selected macroblock has reached the preset threshold count value, the selected macroblock is determined to be intra-coded and is thereby intra-coded at step 35 by encoder 4, irrespective of the SAD matching selecting the macroblock for inter-coding. Following step 35, the inter-coding pixel history count values for the pixel locations of the selected macroblock are reset to zero in step 36. Thus the resetting step 36 is effected if the macroblock for inter-coding (potential inter-coded area)is intra-coded.

If at step 34 the inter-coding history count value for the macroblock has not reached the preset threshold count value, the macroblock is inter-coded at step 38 by the encoder 4.

After steps 36 or 38 the method 20 the effects a test step 37 to determine if all macroblocks in the current frame have been selected and coded. If there are more macroblocks to be coded then the method 20 returns to step 30, otherwise a last frame test step 40 is effected. Test step 40 tests if the final frame of the video sequence 8 has been encoded and therefore coding is complete and the method 20 terminates, otherwise the method 20 returns to step 25 for encoding of macroblocks of further frames of the video sequence.

Hence, by monitoring the encoding of each pixel of each macroblock position in each frame of the video sequence 8 to determine when each macroblock should be intra-coded and therefore refreshed, the dependence chain between frames is limited to the preset threshold count value, thus ensuring limitation of error propagation between frames.

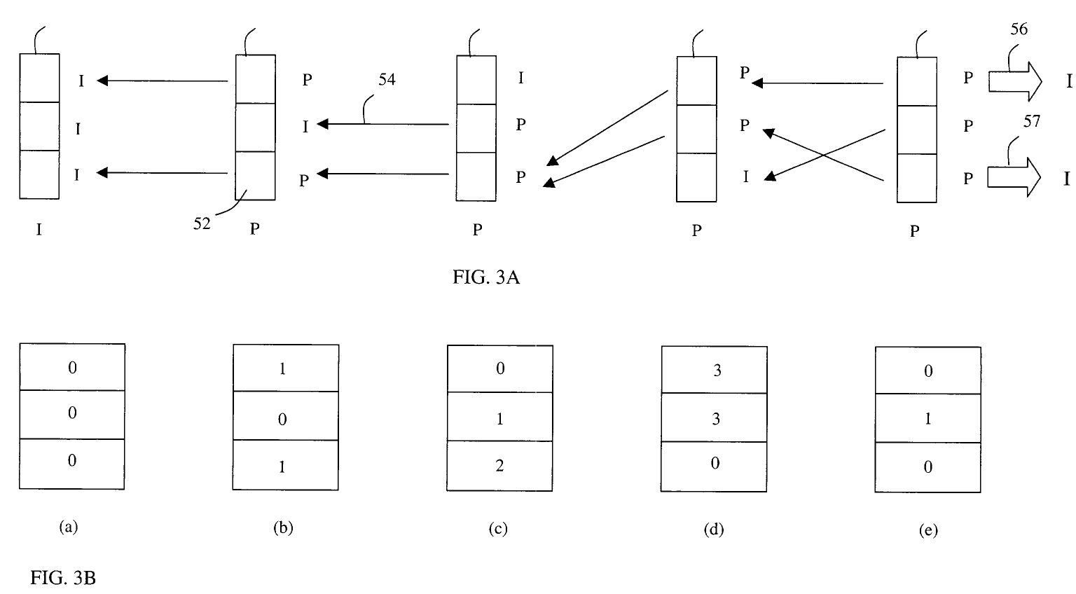

With reference to FIGS. 3A and 3B, a simplified example of the encoding method of the present invention will now be described. In this simplified example it is assumed that a frame is composed of only three macroblocks and that the predictions for these macroblocks for inter-coding are always a single macroblock from the previous frame. Thus in this simplified example, each macroblock in the current frame can only have three blocks as predictors from the previous frame, these being the three individual macroblocks of the previous frame. Although the inter-coding history count value is maintained for every pixel location, in this simplified example an average inter-coding pixel history count is only shown for every macroblock. It should be noted, and will be apparent to a person skilled in the art, that macroblocks in a current frame are not confined to a specific location and will typically overlap at least two corresponding areas of a macroblock of a previous frame. Thus, in practice a potential inter-coded area (macroblock) occupys a different area position than an associated inter-coded area (macroblock) in a previous frame.

FIG. 3A represents a series of frames of the video sequence 8. Frame 42 represents the wholly intra-coded frame and each subsequent frame 44, 46, 48 and 50 is shown as being comprised of three macroblocks 52 for simplicity. Encoding of frame 44 is based on that of frame 42 and encoding of frame 46 is based that of frame 44 and so on, in accordance with the SAD matching as previously referenced herein.

Frame 42 is labeled as an independent frame (I-frame) since it has been wholly intra-coded and is independent of any other frame. Frames 44-50 are labeled as predictive frames (P-frames) since their coding depends on previous frames. The letter adjacent each macroblock denotes the type of encoding for that macroblock. P represents inter-coding and I represents intra-coding. The arrows 54 in FIG. 3A represent motion vector references between macroblocks of adjacent frames when a block is inter-coded.

With reference to FIG.3B, blocks (a)-(e) show the inter-coding history count value for each macroblock position in frames 42-50 respectively in FIG. 3A. Hence, each of the macroblock positions of frame 42 has a zero count value because all macroblocks in this frame have been intra-coded or ‘refreshed’.

With reference to FIG. 3A, top and bottom macroblocks of frame 44 are inter-coded from the top and bottom macroblock respectively of frame 42. Hence, the inter-coding history count value for the top and bottom macroblock positions is incremented by 1 as shown in block (b) in FIG. 3B. In contrast, the central macroblock in frame 44 is intra-coded and has no dependence on frame 42. Therefore, the inter-coding history count value for the central macroblock position remains at zero.

The central and bottom macroblocks of frame 46 are both inter-coded from the central and bottom macroblocks respectively of frame 44, whereas the top macroblock of frame 46 is intra-coded. Hence, with reference to block (c) in FIG. 3B, the inter-coding history count values for the central and bottom macroblock positions are each incremented by 1, whereas the inter-coding history count value for the top macroblock position is reset to zero since the top macroblock of frame 46 has been refreshed.

The top and central macroblocks of frame 48 are both dependent on the bottom macroblock of frame 46 as denoted by the motion vector references. These macroblocks of frame 48 are both inter-coded based on the bottom macroblock of frame 46, which already has the inter-coding history count value for the bottom macroblock position of 2. Therefore, the inter-coding history count values for the top and central macroblock positions of frame 48 are both incremented to 3, as shown in block (d) in FIG. 3B. The bottom macroblock of frame 48 is intra-coded and the inter-coding history count value for the bottom macroblock position is therefore reset to zero.

In this simplified example, the historical preset threshold count value referred to in step 34 of the method is set to a value of 3. Therefore, if the top macroblock of frame 50 were to be inter-coded in accordance with the best matching prediction method, the inter-coding history count value for the top macroblock position would exceed the preset count threshold value. Therefore, in accordance with the method of the present invention, the top macroblock is determined to be intra-coded, as indicated by the arrow 56 in FIG. 3A. Similarly, the bottom macroblock of frame 50 has a dependence on the central macroblock of frame 48, which also has an inter-coding history count value of 3. Therefore, the bottom macroblock is also determined to be intra-coded.

Hence, the inter-coding history count values of the top and bottom macroblocks of frame 50 are reset to zero, as shown in block (e) of FIG. 3B, thus preventing the dependency chain between frames from extending beyond the limit set by the preset threshold count value.

Although the central macroblock of frame 50 is also selected to be inter-coded, this is permitted because it is dependent on the bottom macroblock of frame 48, which only has the inter-coding history count value of zero. The inter-coding history count value for the central macroblock is therefore 1 since historically inter-coding has only been performed once for the central macroblock.

The method of the present invention thus limits the propagation of errors between video frames by limiting the inter-coding history according to a preset threshold count value. Inter-coding history count values are maintained for each area of each frame and are prevented from exceeding the preset threshold count value. The present invention offsets the efficiency of inter-coding with the error resilience of intra-coding and only refreshes the frame areas when necessary. The error resilience of the present invention renders it suitable for encoding video data streams that are to be transmitted over error prone networks.

The embodiment has been described with reference to macroblocks of the frames, which may be comprised of, for example, an array of 16×16 pixels. However, the present invention is not limited to encoding being performed either on macroblocks per se or on macroblocks of this particular size. The encoding of the present invention may be performed on other sized and/or shaped areas or regions of the frames.

The detailed description provides preferred exemplary embodiments only, and is not intended to limit the scope, applicability, or configuration of the invention. Rather, the detailed description of the preferred exemplary embodiments provides those skilled in the art with an enabling description for implementing a preferred exemplary embodiment of the invention. It should be understood that various changes may be made in the function and arrangement of elements without departing from the spirit and scope of the invention as set forth in the appended claims.

We claim:

1. A method of encoding video frames of a video sequence, wherein the frames are divided into areas encoded as either an inter-coded area or an intra-coded area, the inter-coded area having a dependency upon a coded area of a previous frame and the intra-coded area having no dependency upon any coded area of a previous frame, said encoding method including the steps of:
identifying potential inter coded areas of a frame;
maintaining an inter-coding history count value for each of the potential inter-coded areas to be coded, said inter-coding history count value identifying a number of times said potential inter-ceded area depends from inter-coded areas of previous consecutive said frames; and
determining if any of said potential inter-coded areas is to be intra-coded or inter-coded, said determining being dependent upon comparing said inter-coding history count value with a threshold value.

2. A method as claimed in claim 1, wherein said step of maintaining said inter-coding history count value for each of said potential inter-coded areas includes incrementing inter-coding pixel history count values for each pixel in the potential inter-coded area with corresponding pixels having an identical relative positions in the inter-coded areas in previous consecutive frames, wherein the inter-coding history count value is obtained from the inter-coding pixel history count values.

3. A method as claimed in claim 1, further characterized by said step of maintaining said inter-coding history count value for each of said potential inter-coded areas includes resetting the inter-coding pixel history count values for each pixel in the potential inter-coded area, the resetting being effected if the potential inter-coded area is intra-coded.

4. A method as claimed in claim 1, further characterized by said potential inter-coded area occupying a different area position than an associated inter-coded area in a previous frame.

5. A method as claimed in claim 1, wherein said method steps are preceded by an initialization step wherein the areas of said frames are either inter-coded or intra-coded.

6. A method as claimed in claim 5, wherein the initialization step is characterized by said areas of said frames are either inter-coded or intra-coded according to a pre-programmed selective ratio.

7. A method as claimed in claim 1, wherein the initialization step is effected until a predefined number of initial frames have been coded.

8. A video encoder in which frames of a video sequence are divided into areas encoded as either an inter-coded area or an intra-coded area, an inter-coded area having a dependency upon a coded area of a previous frame and an intra-coded area having no dependency upon any coded area of a previous frame, said video encoder comprising:
a counter which maintains an inter-coding history count value for each identified potential inter coded area of a frame said inter-coding history count value identifying a number of times said potential inter-coded area depends from inter-coded areas of previous consecutive said frames;
a comparator which compares each said inter-coding history count value with a threshold count value; and
an encoder unit which determines if any of said potential inter-coded areas is to be intra-coded or inter-coded, said determining being dependent upon comparing each said inter-coding history count value with said threshold count value.

9. A video encoder as claimed in claim 8, wherein the counter maintains said inter-coding history count value for each of said potential inter-coded areas and in use increments inter-coding pixel history count values for each pixel in the potential inter-coded area with corresponding pixels having an identical relative positions in the inter-coded areas in previous consecutive frames, wherein the inter-coding history count value is obtained from the inter-coding pixel history count values.

10. A video encoder as claimed in claim 9, wherein the counter maintains said inter-coding history count value for each of said potential inter-coded areas may in use reset the inter-coding pixel history count values for each pixel in the potential inter-coded area, the reset being effected if the potential inter-coded area is intra-coded.

11. A video encoder as claimed in claim 8, wherein the video encoder is adapted to perform an initialization step in which the areas of said frames are either inter-coded or intra-coded.

12. A video encoder as claimed in claim 11, wherein the initialization step is characterized by said areas of said frames are either inter-coded or intra-coded according to a pre-programmed selective ratio.

13. A video encoder as claimed in claim 11, wherein the initialization step is effected until a predefined number of initial frames have been coded.
